(19) United States
(12) Patent Application Publication
(10) Pub. No.: US 2006/0166056 A1
(43) Pub. Date: Jul. 27, 2006

(54) Fuel cell power generation system

(76) Inventors: Akinari Nakamura, Osaka (JP); Masataka Ozeki, Osaka (JP); Yoshikazu Tanaka, Kyoto (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/532,739

(22) PCT Filed: Jul. 26, 2004
(86) PCT No.: PCT/JP04/11113

§ 371 Date: Apr. 26, 2005

(30) Foreign Application Priority Data
Aug. 7, 2003 (JP) 2003-288706

(51) Int. Cl. H01M 8/04; H01M 8/06

(52) U.S. Cl. 429/22; 429/19; 429/20

(57) ABSTRACT

A fuel cell system 100 is configured such that, at start-up, a feed gas is injected to an anode through bypass means 18 and 20 and a controller 36 is configured to cause a material supply switch means to operate based on a value output from the material flow rate meter 40 to stop supply of the feed gas to the anode 11a and to then start the supply of the feed gas to the fuel generator 12.

### TECHNICAL FIELD

The present invention relates to a fuel cell system configured to generate electric power using a fuel cell.

### BACKGROUND ART

The conventional fuel cell system mainly comprises a fuel cell configured to generate electric power by consuming a hydrogen-rich reformed gas (fuel gas) in an anode and consuming oxygen in a cathode, a blower configured to supply the oxygen to the cathode, a fuel generator configured to generate a reformed gas through a steam reforming reaction of a feed gas (for example, city gas or natural gas) and steam, a condenser configured to condense steam contained in the reformed gas (off gas) unconsumed in the anode, and a burner configured to heat a reforming catalyst body of the fuel generator by heat exchange with a combustion gas resulting from combustion of the off gas.

In a purge method of a fuel cell system disclosed in Japanese Laid-Open Patent Application Publication No. Sho. 62-276763 or No. 2002-110207, when the fuel cell system starts-up, the interior of the fuel cell system is purged by nitrogen to appropriately inhibit occurrence of abnormal combustion of a gas mixture containing air and a fuel gas.

The nitrogen purge requires a dedicated nitrogen device such as a nitrogen tank or a nitrogen separating and generating device. When the fuel cell system is used as a stationary home distributed power supply, a power supply for electrically-powered car, etc, the nitrogen device imposes a limitation on cost reduction and size compactness of the fuel cell system.

As a replacement of the nitrogen purge at the start-up of the fuel cell system, a feed gas purge technique is known, in which the interior of the fuel cell system is purged by the feed gas. For example, the fuel cell system disclosed in US2003/0104711A1 discloses a purge gas system technique which is configured to perform control such that a desulfurization gas (feed gas from which a sulfur component has been removed) which has passed through a bypass passage is guided from a fuel gas supply pipe to an anode, which is purged by the feed gas, which is then guided to the fuel generator (see FIGS. 6 and 7 and the associated parts).

Inventors or the like consider that it is necessary to surely complete the feed gas purge for the anode of the fuel cell system at least before the start of the supply of the feed gas to the fuel generator in order to stabilize a reforming reaction in the fuel generator for the reason which will be described later. In the fuel cell system using the feed gas purge technique, a function for determining a stop time of the feed gas purge for the anode is essential.

In spite of this fact, in the system disclosed in the US2003/0104711A1 publication, it is difficult to determine the stop time of the feed gas purge for the anode.

### DISCLOSURE OF THE INVENTION

The present invention has been developed to solve the above described problem, and an object thereof is to provide a fuel cell system capable of appropriately determining a stop time of feed gas purge when an anode of the fuel cell system is purged using a feed gas at start-up of the fuel cell system.

In order to achieve the above object, a fuel cell system of the present invention comprises: a fuel generator configured to generate a hydrogen-rich fuel gas by reforming a feed gas; a material supply means configured to supply the feed gas to the fuel generator; a fuel cell configured to generate electric power using the fuel gas supplied from the fuel generator and an oxidizing gas; a bypass means configured to supply the feed gas to an anode of the fuel cell by bypassing the fuel generator; a material supply switch means configured to switch a destination of the feed gas supplied from the material supply means between the fuel generator and the bypass means; a material flow rate meter disposed at a position of a feed gas passage to be located between the material supply means and the anode and configured to measure a flow rate of the feed gas flowing through the bypass means; and a controller, wherein, at start-up of the fuel cell system, the feed gas is injected to the anode through the bypass means, and the controller is configured to cause the material supply switch means to operate based on a value output from the material flow rate meter to stop supply of the feed gas to the anode, and to then start the supply of the feed gas to the fuel generator.

Thereby, it is possible to gain a fuel cell system capable of approximately determining a stop time of the feed gas purge when the anode is purged using the feed gas at the start-up of the system.

The fuel cell system may further comprise a desulfurization device provided in the feed gas passage and configured to remove a sulfur component from a city gas which is the feed gas.

The fuel cell system may further comprise a combustor configured to heat the fuel generator by combusting the feed gas supplied to the anode through the bypass means and exhausted from the anode, or the feed gas supplied from the material supply means.

The fuel cell system may further comprise a material flow rate adjusting means provided upstream of the material supply switch means and configured to adjust a flow rate of the feed gas supplied from the material supply means.

Thereby, it is possible to avoid a rapid fluctuation in the supply of the feed gas to burner, thereby keeping a combustion state of the burner stable.

The fuel cell system may further comprise an air supply means configured to supply air to at least one of the anode and the fuel generator, wherein after the air supply means supplies the air to at least one of the anode and the fuel generator and stops the supply of the air, the feed gas is supplied to the anode through the bypass means.

Thereby, since a combustible gas remaining in the anode or the fuel generator is purged and replaced by the air in the interior of the anode when the fuel cell system starts-up, the temperature increase of the fuel generator can be carried out appropriately.

The above and further objects and features of the invention will more fully be apparent from the following detailed description with accompanying drawings.

### BRIEF DESCRIPTION OF THE DRAWINGS

FIG. 1 is a block diagram showing a construction of a fuel cell system according to a first embodiment of the present invention;

FIG. 2 is a block diagram showing a modification of a material supply switch means of the first embodiment;

FIG. 3 is a block diagram showing a construction of a fuel cell system according to a second embodiment of the present invention;

FIG. 4 is a block diagram showing a construction of a fuel cell system according to a third embodiment of the present invention;

FIG. 5 is a block diagram showing a construction of a fuel cell system according to a fourth embodiment of the present invention;

FIG. 6 is a block diagram showing a construction of a fuel cell system according to a fifth embodiment of the present invention;

FIG. 7 is a block diagram showing a modification of a material supply switch means of the fifth embodiment;

FIG. 8 is a block diagram showing a construction of a fuel cell system according to a sixth embodiment of the present invention; and

FIG. 9 is a block diagram showing a modification of a portion (air supply means and pressure increasing device) indicated by a broken line in FIG. 8.

### BEST MODE FOR CARRYING OUT THE INVENTION

Hereinafter, embodiments of the present invention will be described with reference to the drawings.

### EMBODIMENT 1

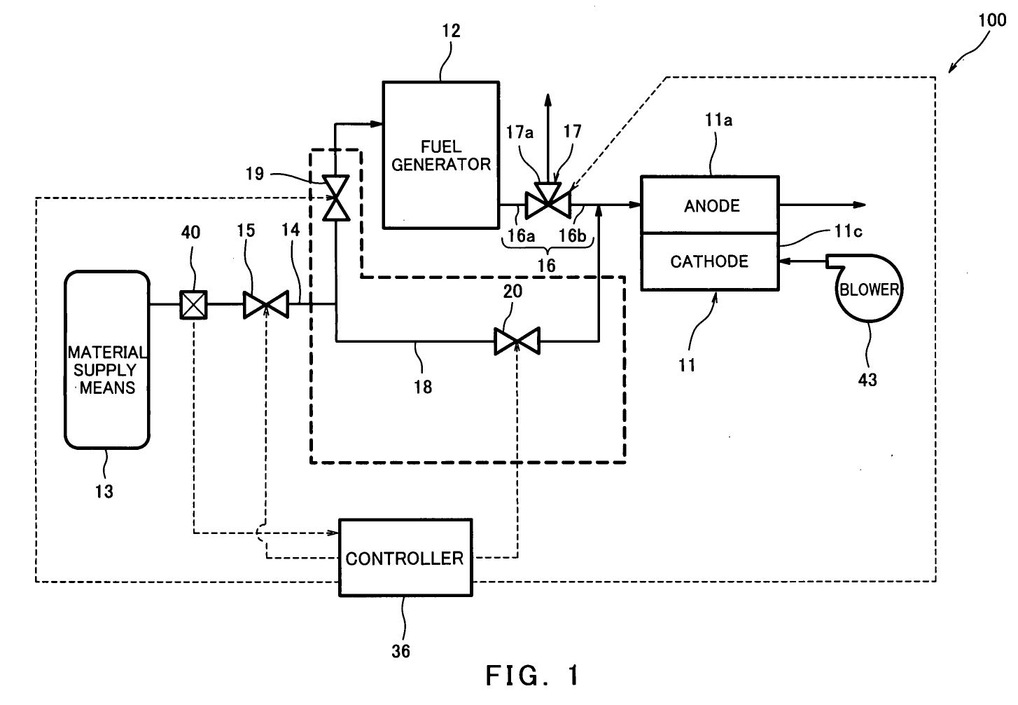

FIG. 1 is a block diagram showing a construction of a fuel cell system according to a first embodiment of the present invention.

A fuel cell system 100 comprises, as main components, a fuel cell 11 configured to generate electric power by consuming a hydrogen-rich reformed gas (fuel gas) in an anode 11a and consuming oxygen (oxidizing gas) in a cathode 11c, a blower 43 configured to supply the oxygen to the cathode 11c, a fuel generator 12 configured to generate a hydrogen-rich fuel gas by steam-reforming a feed gas comprising a compound containing at least carbon and hydrogen, for example, methane, a natural gas or propane, and a material supply means 13 configured to supply a material to the fuel generator 12.

A gas supply system of the fuel cell system 100 includes, from upstream side in the flow of the feed gas, a material supply passage 14 through which a feed gas is guided from the material supply means 13 to the fuel generator 12, a fuel gas supply passage 16 through which the fuel gas is guided from the fuel generator 12 to an anode 11a of the fuel cell 11, a first bypass passage 18 configured to branch from a position of the material supply passage 14 and to be connected to a position of the fuel gas supply passage 16, a primary material supply valve 15 disposed at a position of the material supply passage 14 to be located upstream of a position where the first bypass passage 18 branches from the material supply passage 14 and configured to permit and not to permit the supply of the feed gas to downstream side, a material flow rate meter 40 disposed at a position of the material supply passage 14 to be located between the material supply means 13 and the primary material supply valve 15 and configured to detect a flow rate of the feed gas and to measure an integrated flow rate of the feed gas, a secondary material supply valve 19 disposed at a position of the material supply passage 14 to be located downstream of the position where the first bypass passage 18 branches and configured to permit and not to permit the supply of the feed gas to the fuel generator 12, a material bypass valve 20 disposed at a position of the first bypass passage 18 and configured to permit and not to permit supply of the feed gas to the anode 11a, and a fuel gas switch valve 17 disposed at a position of the fuel gas supply passage 16 to be located upstream of a position where the first bypass passage 18 is connected to the fuel gas supply passage 16 and configured to be capable of switching destination of the fuel gas between the anode 11a of the fuel cell 11 and another device (not shown). The material supply means 13 may include, for example, a tank filled with hydrocarbon, a valve provided in a city gas pipe, etc.

An operation for flowing the feed gas through the first bypass passage 18, opening and closing operation of the secondary material supply valve 19, and opening and closing operation of the material bypass valve 20 allow the feed gas flowing through the material supply passage 14 to be guided to the fuel gas supply passage 16 through the first bypass passage 18 which branches from the passage 14, so as to bypass the fuel generator 12, and to be further guided to the anode 11a on downstream side.

In other words, the material supply switch operation is accomplished by the opening and closing operation of the secondary material supply valve 19 and the opening and closing operation of the material bypass valve 20. A specific embodiment as the bypass means includes the first bypass passage 18 and the material bypass valve 20.

As an alternative of the material flow rate meter 40 configured to measure the flow rate of the feed gas and to measure the integrated flow rate, a material flow rate meter having a similar configuration may be disposed in the first bypass passage 18.

The controller 36 receives a detection signal corresponding to the integrated flow rate which is output from the material flow rate meter 40 and appropriately controls operations of the secondary material supply valve 19 and the material bypass valve 20 based on this signal.

The controller 36 also controls an operation of the whole fuel cell system 100, although not shown.

Subsequently, an example of an operation of the fuel cell system 100 according to the first embodiment will be described. The operation of the fuel cell system 100 of the first embedment will be described in connection with an embodiment of a power generation method thereof (the same applies to second through sixth embodiments).

When the fuel cell system 100 starts-up, the controller 36 opens the primary material supply valve 15 and the material bypass valve 20 and closes the secondary material supply valve 19.

The controller 36 carries out a switch operation of the fuel gas switch valve 17 to connect a portion 16a of the fuel gas supply passage 16 on the fuel generator 12 side to a port through which the fuel gas is not supplied to the fuel cell 11 (exhaust port 17a through which the fuel gas is exhausted outside).

Under this condition, the feed gas flowing from the material supply means 13 through the material supply passage 14 is guided to a portion 16b of the fuel gas supply passage 16 on the fuel cell 11 side through the first bypass passage 18. Then, the feed gas is injected from the portion 16b into the anode 11a to purge the interior of the anode 11a and thereafter is exhausted outside through an exhaust passage of the anode 11a.

The controller 36 monitors the detection signal output from the material flow rate meter 40 and detects the integrated flow rate of the feed gas passing therethrough. The controller 36 compares the integrated flow rate to an internal volume (known volume) of the fuel cell system 100 obtained by adding a volume of the first bypass passage 18, a volume of the anode 11, etc.

The controller 36 controls the gas supply system of the fuel cell system 100 so that the integrated flow rate of the feed gas for the purge becomes at least the above described internal volume or more.

In order to fully purge the gas filled within the fuel cell system 100 using the feed gas, it is necessary to set the amount of supply of the feed gas to at least not less than the internal volume (4 to 5 liters) of the fuel cell system 100, more preferably approximately three times as much as the internal volume of the fuel cell system 100.

Subsequently, after a predetermined amount (e.g., amount three times as much as the internal volume of the fuel cell system 100) of the feed gas for the purge has been supplied as the integrated flow rate to the anode 11a, the controller 36 closes the material bypass valve 20.

Thereafter, the controller 36 opens the secondary material supply valve 19. Thus, after injection of the feed gas to the anode 11a has been completed, the supply of the feed gas to the fuel generator 12 starts.

The controller 36 has a function to determine a stop time of the feed gas purge for the anode 11a based on the integrated flow rate (output value of the material flow meter 40) of the feed gas which is obtained by the material flow meter 40.

Meanwhile, the feed gas supplied to the fuel generator 12 is reformed along with steam in a reforming catalyst body (not shown) in a high temperature condition to generate a hydrogen-rich fuel gas. The fuel generator 12 has a function to appropriately remove carbon monoxide from the reformed fuel gas. Thereby, the concentration of the carbon monoxide contained in the fuel gas is lowered to a level or less at which the carbon monoxide will not damage platinum (Pt) based electrode catalyst of the fuel cell 11.

During a predetermined time period from the start-up of the fuel generator 12, it is difficult to lower the concentration of the carbon monoxide in the fuel gas to a predetermined level or less, because the fuel generator 12 cannot sufficiently exhibit the function to remove the carbon monoxide due to a low temperature of the interior thereof.

For this reason, during the predetermined time period, the controller 36 keeps the condition of the fuel gas switch valve 17 as it is (condition in which the portion 16a of the fuel gas supply passage 16 on the fuel generator 12 side communicates with the exhaust port 17a to outside) to prevent the supply of the fuel gas to the anode 11a.

The fuel gas exhausted outside may be supplied to a burner configured to heat the fuel generator 12 or another burner (not shown) and may be combusted therein.

When the concentration of the carbon monoxide in the fuel gas has been lowered to the predetermined level or less, the controller 36 causes the fuel gas switch valve 17 to switch so that the fuel gas supply passage 16 communicate with the anode 11a. Thereby, the fuel gas is supplied to the anode 11a through the fuel gas supply passage 16 and is used for power generation in the fuel cell 11 along with the air of the cathode 11c.

The off gas (gas mixture containing hydrogen, steam, carbon dioxide, and carbon monoxide) unconsumed in the power generation is exhausted from the anode 11a outside the fuel cell 11. The off gas exhausted outside may be supplied to the burner configured to heat the fuel generator 12 or another burner (not shown) and may be combusted therein.

The fuel cell system 100 constructed above provides function and effects as described below.

First, since the controller 36 has a function to stop the feed gas purge for the anode 11a, and determines the stop time of the feed gas purge for the anode 11a based on the integrated flow rate of the feed gas which is obtained by the material flow meter 40, it ensures a procedure in which the supply of the feed gas to the fuel generator 12 starts after the feed gas purge for he anode 11a has been completed.

If both of the processes proceed concurrently, the internal volume of the fuel generator 12 increases due to an increase in molecular weight or an increase in a temperature of the interior of the fuel generator 12, as the reforming reaction progresses in the interior of the fuel generator 12. This causes a loss in an internal pressure of the fuel generator 12, thereby causing a fluctuation in the flow rate of the feed gas supplied to the fuel generator 12 and a fluctuation in the flow rate of the feed gas to purge the anode 11a. Finally, this may lead to an unstable flame in the burner or an unstable reforming reaction in the fuel generator 12.

If the above described procedure is reversed, then the flow rate of the gas supplied to the burner becomes imbalanced upon the start of the supply of the feed gas to the anode 11a. This may lead to the unstable flame in the burner or the unstable reforming reaction in the fuel generator 12.

Secondly, as described below, it is possible to appropriately purge the air remaining in the anode 11a by the feed gas to inhibit occurrence of abnormal combustion caused by mixing of the fuel gas and the air.

Specifically, during the stop time period of the system, the air may enter a passage located downstream of the fuel cell 11. The air may disperse to the anode 11a and remain in the vicinity of the platinum based electrode catalyst in the interior of the anode 11a. Or, the air existing in the cathode 11c may diffuse to the anode 11a through an electrolyte membrane (not shown) and remain in the vicinity of the electrode catalyst in the interior of the anode 11a.

Under this condition, if the fuel gas (hydrogen) is inadvertently supplied to the anode 11a in which the air remains at next start-up, the gas mixture of oxygen and hydrogen may be abnormally combusted by the function of the platinum based electrode catalyst of the anode 11a, because the gas mixture of hydrogen and oxygen has a wide combustible range (combustible range of hydrogen: 4% to 75%) and is able to react at a low temperature by the function of the platinum based catalyst.

On the other hand, since a gas mixture of the feed gas (e.g., methane) and oxygen has a combustible range (combustible range of methane: 5% to 15%) much narrower than that of hydrogen and does not react at a low temperature, the feed gas is injected to the anode 11a in advance to purge the gas (e.g., air) remaining in the anode 11a. Thus, the mixing of the hydrogen and the oxygen in the anode 11a can be avoided.

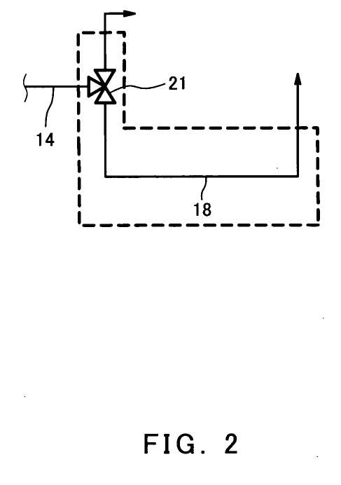

While the material supply switch means includes the first bypass passage 18 (bypass means), the secondary material supply valve 19, and the material bypass valve 20 (bypass means), which correspond to a portion defined by a broken line in FIG. 1, it may alternatively include the first bypass passage 18 and a material switch valve 21 configured to switch the destination of the feed gas flowing through the material supply passage 14 between the fuel generator 12 and the first bypass passage 18, as shown in FIG. 2.

In this case, a specific embodiment of the bypass means includes the first bypass passage 18 and the material switch valve 21. In this construction, when the fuel cell system 100 starts-up, the controller 36 opens the primary material supply valve 15 and causes the material switch valve 21 to switch so that the material supply passage 14 and the first bypass passage 18 communicate with each other. And, the feed gas sent from the material supply means 13 is injected to the anode 11a through the first bypass passage 18.

### EMBODIMENT 2

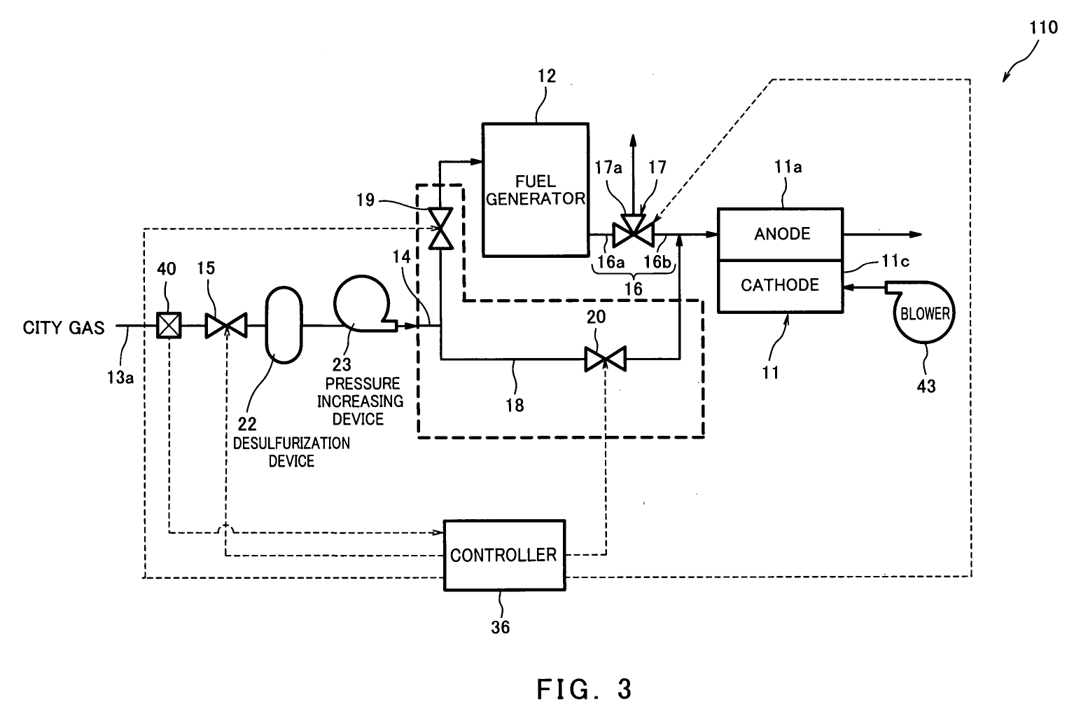

FIG. 3 is a block diagram showing a construction of a fuel cell system according to a second embodiment of the present invention. In FIG. 3, the same reference numerals as those in FIG. 1 denotes the same components, which will not be further described.

A fuel cell system 110 comprises, in addition to the components of the fuel cell system 100 of FIG. 1, a desulfurization device 22 configured to remove a sulfur component having corrupt smell from the city gas, and a pressure increasing device 23 configured to increase the pressure of the city gas to a predetermined pressure. As the material supply means 13, a valve (not shown) provided in a city gas pipe 13a is used.

Subsequently, an example of an operation of the fuel cell system 110 will be descried. It should be appreciated that the operation identical to the operation of the fuel cell system 100 of the first embodiment will be described briefly.

When the fuel cell system 110 starts-up, the controller 36 opens the primary material supply valve 15 and the material bypass valve 20, and closes the secondary material supply valve 19. Simultaneously, the controller 36 causes the fuel gas switch valve 17 to switch to a fuel gas exhaust side and the pressure increasing device 23 to operate.

The city gas is guided to the desulfurization device 22 through the city gas pipe 13a, and its sulfur component is removed in the desulfurization device 22. Thereafter, the city gas is pressure-increased to the predetermined pressure by the pressure increasing device 23 and sent out to the material supply passage 14. Then, the city gas is guided from the material supply passage 14 to the anode 11a through the first bypass passage 18. The city gas purges the interior of the anode 11a and is exhausted outside through an exhaust passage of the anode 11a.

Subsequently, the controller 36 closes the material bypass valve 20 to terminate injection of the city gas to the fuel cell 11. Thereafter, the controller 36 opens the secondary material supply valve 19, and the city gas pressure-increased by the pressure increasing device 23 is supplied to the fuel generator 12.

Since the following operation of the fuel cell system 110 is identical to the operation of the fuel cell system 100 of the first embodiment, it will not be further described herein.

The fuel cell system 110 provides effects as described below in addition to the effects obtained in the first embodiment.

Since the city gas from which the sulfur component has been removed is injected to the anode 11a, sulfur poisoning of the anode 11a can be prevented. Thereby, durability of the fuel cell 11 can be improved. When the purge is carried out using the city gas, the pressure of which has been increased in the pressure increasing device 23 from approximately 2 kPa, the flow rate of the city gas for the purge can be varied by varying the power of the pressure increasing device 23. As a result, the purge can be carried out at an optimum flow rate of the city gas and at an optimum purge time.

While the material supply switch means includes the first bypass passage 18 (bypass means), the secondary material supply valve 19, and the material bypass valve 20 (bypass means), which correspond to a portion defined by a broken line of FIG. 3, it may alternatively include the first bypass passage 18 and the material switch valve 21 configured to switch the destination of the city gas flowing through the material supply passage 14 between the fuel generator 12 and the first bypass passage 18 as shown in FIG. 2.

In this case, a specific embodiment of the bypass means includes the first bypass passage 18 and the material switch valve 21.

### EMBODIMENT 3

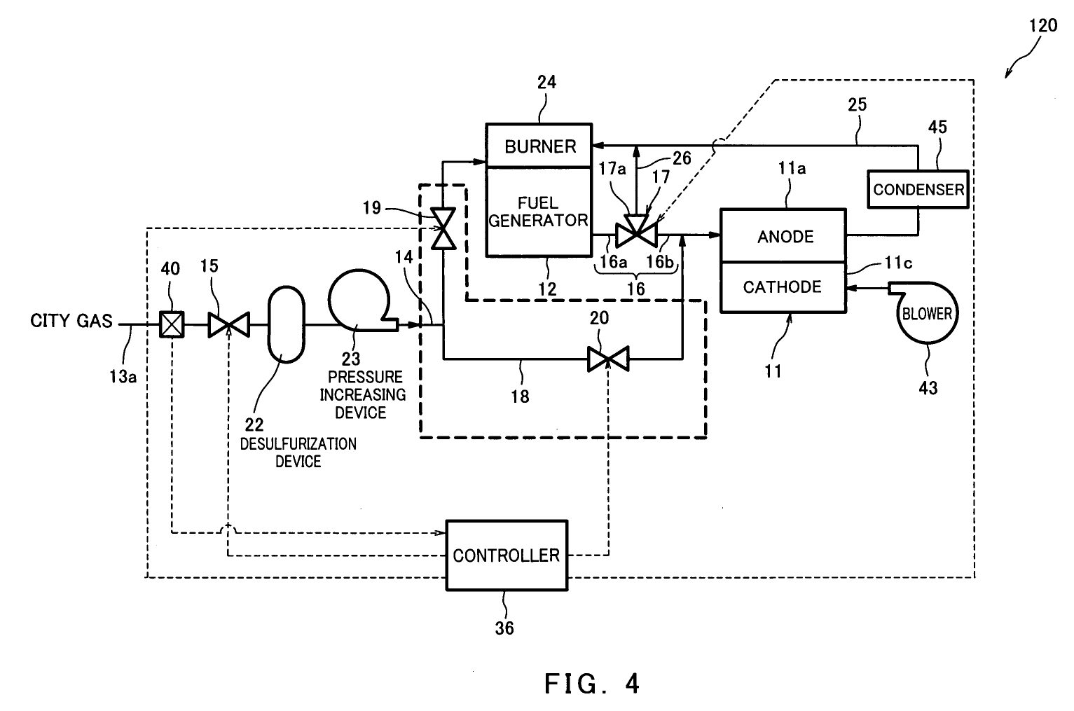

FIG. 4 is a block diagram showing a construction of a fuel cell system according to a third embodiment of the present invention. In FIG. 4, the same reference numerals as those in FIG. 3 denotes the same components, which will not be further described.

A fuel cell system 120 comprises, in addition to the components of the fuel cell system 110 of FIG. 3, a burner (combustor) 24 configured to keep the fuel generator 12 at a high temperature to allow a reforming reaction to be conducted therein, a fuel gas exhaust passage 25 through which an exhaust fuel gas (off gas or purge gas which has been used for the purge) which is exhausted from the anode 11a is supplied to the burner 24, a condenser 45 disposed at a position of the fuel gas exhaust passage 25 and configured to remove steam from the fuel gas, and a second bypass passage 26 connecting the fuel gas supply passage 16 to the fuel gas exhaust passage 25 by the switching operation of the fuel gas switch valve 17 and configured to guide the gas sent out from the fuel generator 12 so as to bypass the anode 11a of the fuel cell 11.

Subsequently, an example of an operation of the fuel cell system 120 will be descried. It should be appreciated that the operation identical to the operation of the fuel cell system 100 and 110 of the first and second embodiments will be described briefly.

When the fuel cell system 120 starts-up, the controller 36 opens the primary material supply valve 15 and the material bypass valve 20, and closes the secondary material supply valve 19. Simultaneously, the controller 36 causes the fuel gas switch valve 17 to switch so that the fuel gas supply passage 16 and the second bypass passage 26 communicate with each other and the pressure increasing device 23 to operate.

The city gas is guided to the desulfurization device 22 through the city gas pipe 13a, and its sulfur component is removed in the desulfurization device 22. Thereafter, the city gas is pressure-increased to a predetermined pressure by the pressure increasing device 23 and sent out to the material supply passage 14. Then, the city gas is guided from the material supply passage 14 to the anode 11a through the first bypass passage 18. The city gas purges the interior of the anode 11a and is exhausted outside through the exhaust passage of the anode 11a. The city gas exhausted outside from the anode 11a is sent to the burner 24 through the fuel gas exhaust passage 25 and is combusted therein to generate a high-temperature combustion gas. The fuel generator 12 is heated by heat exchange with the combustion gas. After heating the fuel generator 12, the combustion gas is discharged to atmosphere.

Subsequently, the controller 36 closes the material bypass valve 20 to terminate injection of the city gas to the fuel cell 11. Thereafter, the controller 36 opens the secondary material supply valve 19, and thereby, the city gas pressure-increased by the pressure increasing device 23 is supplied to the fuel generator 12.

The city gas sent to the fuel generator 12 is reformed along with steam in the reforming catalyst body (not shown) in a high temperature condition, to generate a hydrogen-rich fuel gas. The fuel generator 12 contains a function to appropriately remove carbon monoxide from the fuel gas after the reforming reaction, thereby lowering the concentration of carbon monoxide to a level or less at which platinum (Pt)-based electrode catalyst of the fuel cell 11 will not be damaged.

During a predetermined time period from the start-up of the fuel generator 12, it is difficult to lower the concentration of the carbon monoxide in the fuel gas to a predetermined level or less, because the fuel generator 12 cannot sufficiently exhibit the function to remove the carbon monoxide due to a low temperature of the interior thereof.

For this reason, during the predetermined time period, the controller 36 keeps the condition of the fuel gas switch valve 17 as it is (condition in which the fuel gas supply passage 16 and the second bypass passage 26 communicate with each other) to prevent the supply of the fuel gas to the anode 11a. The fuel gas containing carbon monoxide in large amount is sent to the fuel gas exhaust passage 25 through the second bypass passage 26 and then is supplied to the burner 24 configured to heat the fuel generator 12 to be combusted therein.

When the concentration of the carbon monoxide in the fuel gas has been lowered to the predetermined level or less, the controller 36 causes the fuel gas switch valve 17 to switch so that the fuel gas supply passage 16 and the anode 11a to communicate with each other. Thereby, the fuel gas is supplied to the anode 11a through the fuel gas supply passage 16 and used along with air in the cathode 11c to generate electric power in the fuel cell 11. An off gas (gas mixture of hydrogen, steam, carbon dioxide, and carbon monoxide) unconsumed in the power generation is exhausted from the anode 11a to the fuel gas exhaust passage 25. The off gas is supplied to the burner 24 configured to heat the fuel generator 12, through the fuel gas exhaust passage 25, and is combusted therein.

The fuel cell system 120 provides effects as described below in addition to the effects obtained in the first and second embodiments.

Since the city gas, the sulfur component of which has been removed, purges the interior of the fuel cell 11 and is exhausted from the anode 11a to the burner 24 of the fuel generator 12 to be combusted therein to generate the combustion gas to heat the fuel generator 12, a combustible gas which has been used for the purge can be approximately treated, inadvertent release of the combustible gas outside the system can be prevented, and a combustion heat of the combustible gas can be effectively utilized.

While the material supply switch means includes the first bypass passage 18 (bypass means), the secondary material supply valve 19, and the material bypass valve 20 (bypass means), which correspond to a portion defined by a broken line of FIG. 4, it may alternatively include the first bypass passage 18 and the material switch valve 21 configured to switch the destination of the city gas flowing through the material supply passage 14 between the fuel generator 12 and the first bypass passage 18 as shown in FIG. 2.

In this case, a specific embodiment of the bypass means includes the first bypass passage 18 and the material switch valve 21.

### EMBODIMENT 4

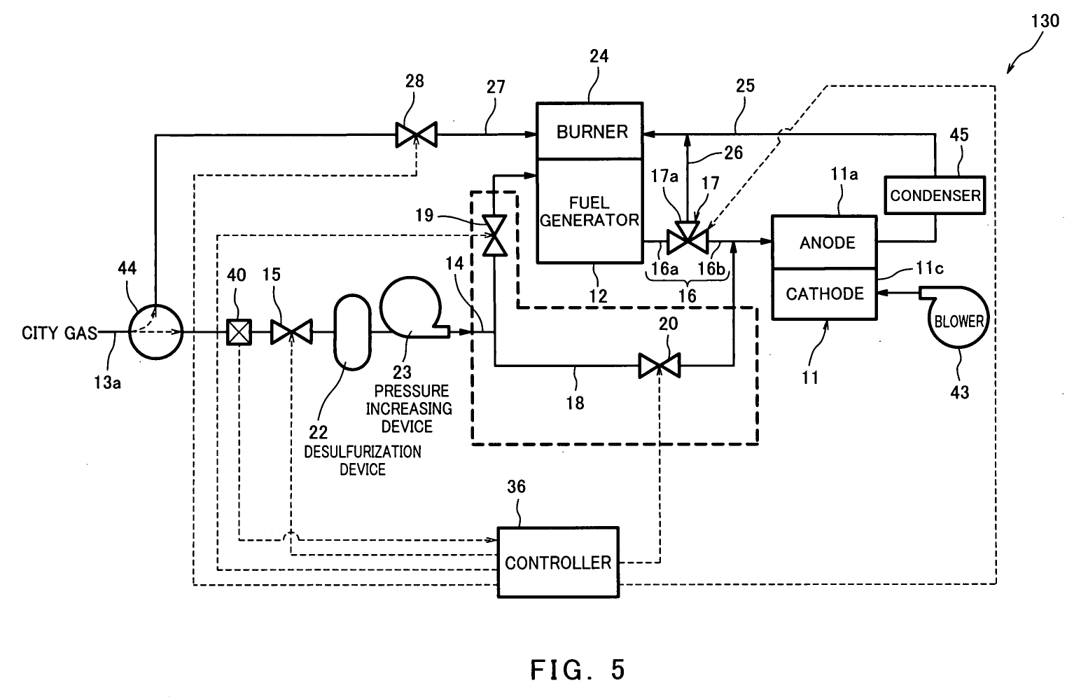

FIG. 5 is a block diagram showing a construction of a fuel cell system according to a fourth embodiment of the present invention. In FIG. 5, the same reference numerals as those in FIG. 4 denotes the same components, which will not be further described.

A fuel cell system 130 comprises, in addition to the components of the fuel cell system 120 of FIG. 4, a feed gas branch passage 27 configured to branch from the city gas pipe 13a to extend to the burner 24 and configured to allow the city gas to be supplied to the burner 24 therethrough, a burner material supply valve 28 disposed at a position of the feed gas branch passage 27 and configured to permit and not to permit supply of the city gas to the burner 24, a flow dividing valve 44 which is disposed at the position where the feed gas branch passage 27 branches from the city gas pipe 13a and is capable of adjusting a flow rate of the city gas flowing through the feed gas branch passage 27 and a flow rate of the city gas flowing through the material supply passage 14. The controller 36 is configured to control opening and closing operation of the burner material supply valve 28 and the flow dividing operation of the flow dividing valve 44.

Subsequently, an example of an operation of the fuel cell system 130 will be descried. It should be appreciated that the operation identical to the operations of the fuel cell systems 100, 110, and 120 of the first to third embodiments will be described briefly.

When the fuel cell system 130 starts-up, the city gas flowing through the city gas pipe 13a is divided by the flow dividing valve 44 into the city gas flowing through the feed gas branch pipe 27 and the city gas flowing through the material supply passage 14 at a proper ratio.

Under this condition, the controller 36 opens the burner material supply valve 28 to supply the city gas to the burner 24 through the feed gas branch passage 27. The city gas is combusted in the burner 24, and the fuel generator 12 exchanges heat with the combustion gas, so that the temperature of the fuel generator 12 quickly increases. The combustion gas which has exchanged heat with the fuel generator 12 is discharged to atmosphere.

Since the operation of the fuel cell system 130 for the city gas flowing through the material supply passage 14 is identical to that of the fuel cell system 120 of the third embodiment, it will not be further described.

The fuel cell system 130 provides effects as described below in addition to the effects described in the first to third embodiments.

Since the temperature increasing operation of the fuel generator 12 by heat exchange with the combustion gas and the purge operation for the anode 11a by injection of the city gas with the sulfur component removed are carried out concurrently, the start-up time period of the fuel cell system 130 can be reduced.

While the material supply switch means includes the first bypass passage 18 (bypass means), the secondary material supply valve 19, and the material bypass valve (bypass means) 20, which correspond to a portion defined by a broken line of FIG. 5, it may alternatively include the first bypass pipe 18, and the material switch valve 21 configured to switch destination of the city gas flowing through the material supply passage 14 between the fuel generator 12 and the first bypass passage 18, as shown in FIG. 2.

In this case, a specific embodiment of the bypass means includes the first bypass passage 18 and the material switch valve 21.

### EMBODIMENT 5

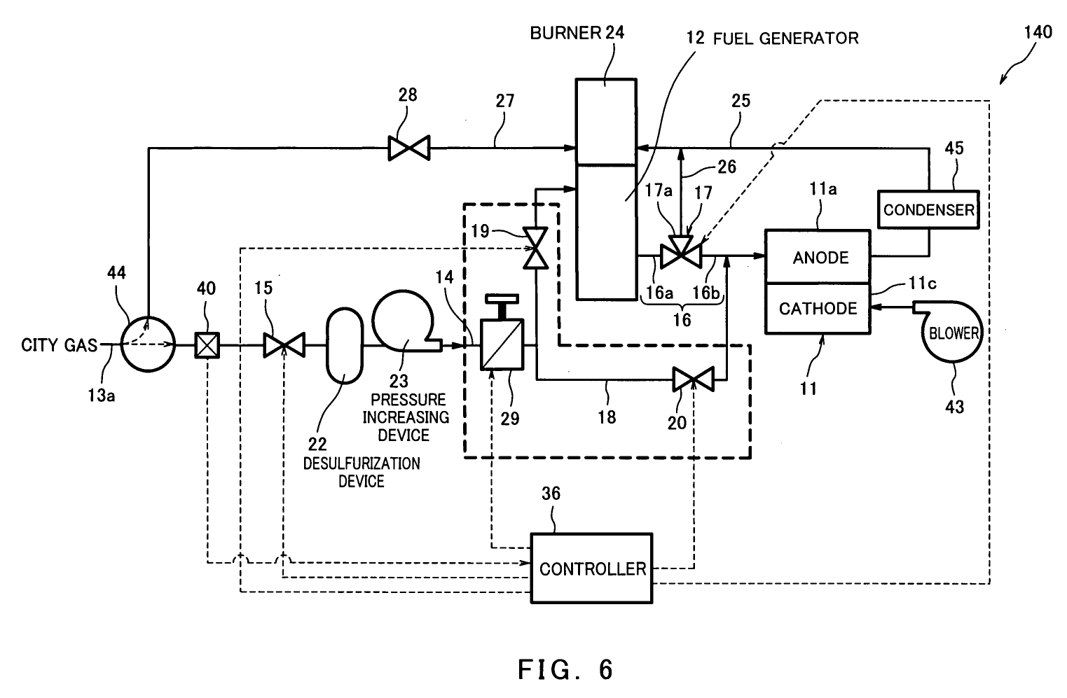

FIG. 6 is a block diagram showing a construction of a fuel cell system according to a fifth embodiment of the present invention. In FIG. 6, the same reference numerals as those in FIG. 5 denotes the same components, which will not be further described.

A fuel cell system 140 comprises, in addition to the components of the fuel cell system 130 of FIG. 5, a material flow rate adjusting valve (material flow rate adjusting means) 29 disposed at a position of the material supply passage 14 to be located downstream of the pressure increasing device 23 and upstream of the position where the first bypass passage 18 branches from the material supply passage 14 and configured to be capable of adjusting a flow rate of the city gas. The adjusting operation of the material flow rate adjusting valve 29 is controlled by the controller 36.

Subsequently, an example of an operation of the fuel cell system 140 will be descried. It should be appreciated that the operation identical to the operation of the fuel cell systems 100, 110, 120, and 130 of the first to fourth embodiments will be described briefly.

When the fuel cell system 140 starts-up, the city gas flowing through the city gas 13a is divided by the flow dividing valve 44 into the city gas flowing through the feed gas branch passage 27 and the city gas flowing through the material supply passage 14 at a proper ratio. Under this condition, the controller 36 opens the burner material supply valve 28 to supply the city gas to the burner 24 through the feed gas branch passage 27. The city gas is combusted in the burner 24 to generate a combustion gas and the fuel generator 12 exchanges heat with the combustion gas, so that the temperature of the fuel generator 12 quickly increases.

Meanwhile, the controller 36 opens the primary material supply valve 15 and the material bypass valve 20, and closes the secondary material supply valve 19. And, the controller 36 causes the fuel gas switch valve 17 to switch so that the fuel gas supply passage 16 and the second bypass passage 26 communicate with each other, and the pressure increasing device 23 to operate.

The city gas is guided to the desulfurization device 22 through the city gas pipe 13a, and its sulfur component is removed in the desulfurization device 22. Thereafter, the city gas is pressure-increased to a predetermined pressure by the pressure increasing device 23 and is sent out to the material supply passage 14. Then, the city gas is guided from the material supply passage 14 to the anode 11a through the first bypass passage 18. The city gas purges the interior of the anode 11a and is exhausted outside from the anode 11a to the fuel gas exhaust passage 25. The city gas is supplied to the burner 24 through the fuel gas exhaust passage 25 and is combusted therein to generate a high-temperature combustion gas. The fuel generator 12 is heated by heat exchange with the combustion gas. After heating the fuel generator 12, the combustion gas is discharged to atmosphere.

Subsequently, when determining that the anode 11a has been purged by the predetermined amount of the city gas described previously, the controller 36 closes the material bypass valve 20 to stop the supply of the city gas to the anode 11a. Following this, the controller 36 opens the secondary material supply valve 19 to start the supply of the city gas to the fuel generator 12.

It should be appreciated that, when the injection of the city gas to the anode 11a starts, the controller 36 adjusts the operation of the material flow rate adjusting valve 29 such that an opening degree of the adjusting valve 29 gradually increases from a fully closed position to a predetermined open position corresponding to a predetermined flow rate. When the injection of the city gas to the anode 11a has been terminated, the controller 36 adjusts the operation of the material flow rate adjusting valve 29 such that the opening degree of the adjusting valve 29 gradually decreases from the predetermined open position to the fully closed position.

Since the following operation of the fuel cell system 140 is identical to the operation of the fuel cell system 130 of the fourth embodiment, it will not be further described herein.

The fuel cell system 140 provides effects as described below in addition to the effects obtained in the first to fourth embodiments.

By the open position adjusting operation of the material flow rate adjusting valve 29, when the injection of the city gas to the anode 11a starts, the amount of the city gas injected to the anode 11a is controlled so as to gradually increase from zero (open position of the adjusting valve 29: fully closed position) to the predetermined flow rate, while when the injection of the city gas to the anode 11a terminates, the amount of the city gas injected to the anode 11a is controlled so as to gradually decrease from the predetermined flow rate to zero. Therefore, a problem that the flow rate of the city gas which has purged the anode 11a and is exhausted from the anode 11a to the burner 24 rapidly changes does not occur. As a result, a combustion state of the burner 24 can be stabilized.

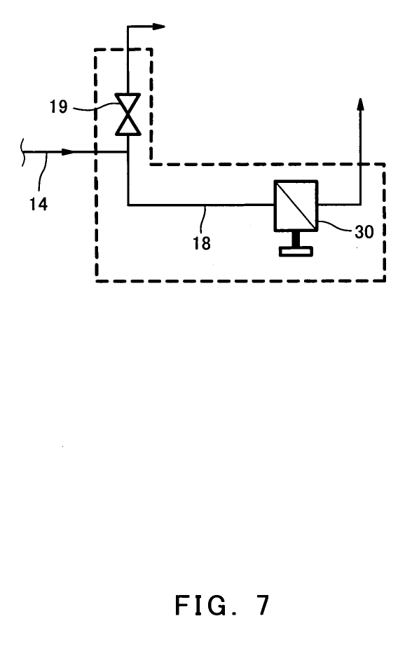

While the material supply switch means includes the first bypass passage 18 (bypass means), the secondary material supply valve 19, the material bypass valve 20 (bypass means), and the material flow rate adjusting valve 24, which correspond to a portion defined by a broken line of FIG. 6, it may alternatively include the first bypass passage 18, the secondary material supply valve 19, and a bypass passage flow rate adjusting valve 30 capable of adjusting the flow rate of the gas flowing through the first bypass passage 18 as shown in FIG. 7. Specifically, by the opening position adjusting operation of the bypass passage flow rate adjusting valve 20, when the injection of the city gas to the anode 11a starts, the amount of the city gas injected to the anode 11a is controlled so as to gradually increase from zero (open position of the adjusting valve 30: fully closed position) to the predetermined flow rate, while when the injection of the city gas to the anode 11a terminates, the amount of the city gas injected to the anode 11a is controlled so as to gradually decrease from the predetermined flow rate to zero.

In this case, a specific embodiment of the bypass means includes the first bypass passage 18 and the bypass passage flow rate adjusting valve 30.

### EMBODIMENT 6

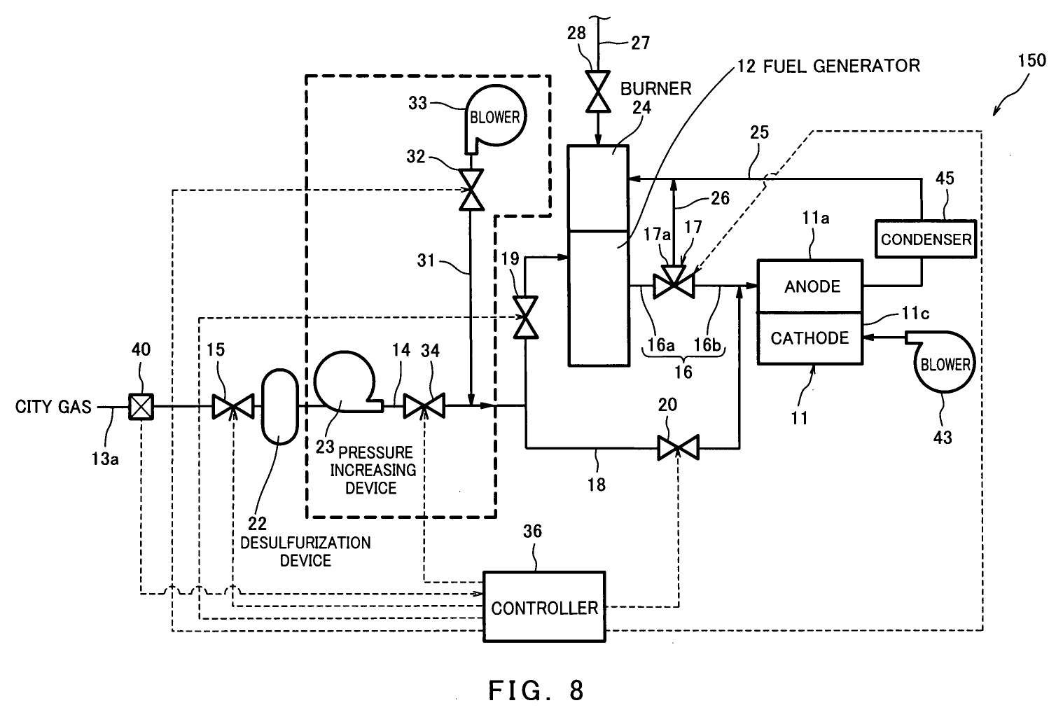

FIG. 8 is a block diagram showing a construction of a fuel cell system according to a sixth embodiment of the present invention. In FIG. 8, the same reference numerals as those in FIG. 5 denotes the same components, which will not be further described.

A fuel cell system 150 comprises, in addition to the components of the fuel cell system 130 of FIG. 5, a blower 33 configured to supply air to the material supply passage 14, an air supply passage 31 through which the air is guided from the blower 33 to the material supply passage 14, a first air valve 32 disposed at a position of the air supply passage 31 and configured to permit and not to permit the supply of the air to the material supply passage 14, and an air anti-backflow valve 34 disposed at a position of the material supply passage 14 to be located downstream of the pressure increasing device 23 and upstream of the position where the air supply passage 31 is connected to the material supply passage 14.

A specific embodiment of the air supply means includes the air supply passage 31, the first air valve 32, the blower 33, and the air anti-backflow valve 34 as shown in FIG. 8. The opening and closing operation of the first air valve 32 is controlled by the controller 36.

Subsequently, an example of an operation of the fuel cell system 140 will be descried. It should be appreciated that the operation identical to the operation of the fuel cell systems 100, 110, 120 and 130 of the first to fourth embodiments will be described briefly.

When the fuel cell system 140 starts-up, the controller 36 opens the secondary material supply valve 19 and the first air valve 32 and closes the material bypass valve 20 and the air anti-backflow valve 34. Further, the controller 36 causes the fuel gas switch valve 17 to switch so that the fuel gas supply passage 16 and the anode 11a communicate with each other.

Under this condition, the controller 36 causes the blower 33 to operate. The air is supplied from the blower 33 to the material supply passage 14 through the air supply passage 31. The air anti-backflow valve 34 does not permit the flow of the air toward the desulfurization device 22. Instead, the air is sent to the fuel generator 12. The air purges the interior of the fuel generator 12 and is sent out to the fuel gas supply passage 16. Then, the air is sent to the anode 11a through the fuel gas supply passage 16. The air purges the anode 11a and is exhausted to the fuel gas exhaust passage 25. Then, the air flows through the condenser 45 and is sent to the burner 24 through the fuel gas exhaust passage 25 to be treated therein. To stop the supply of the air to the material supply passage 14, the controller 36 stops the operation of the blower 33 and closes the first air valve 32.

Since the following operation of the fuel cell system 150 is identical to the operation of the fuel cell system 130 of the fourth embodiment, it will not be further described herein.

The fuel cell system 150 provides effects as described below in addition to the effects obtained in the first to fourth embodiments.

It is assumed that a gas remaining in the anode 11a and the fuel generator 12 at the start-up of the fuel cell system 150 may be air from atmosphere which has entered a downstream side of the gas passage and has been diffused to the anode 11a during a stop period.

Also, it is assumed that the combustible gas (city gas methane, propane, or a natural gas) enters and is diffused in the anode 11a or the like due to some problems such as power failure or vanishment of a burner flame.

In particular, when the combustible gas enters the anode 11a during the stop period of the fuel cell system 150, the combustible gas having assumed calories or more is sent to the burner 24 when the purge is performed using the city gas at next start-up, and consequently, the temperature of the fuel generator 12 may excessively increase.

In order to appropriately deal with such a problem, the gas remaining in the anode 11a and the fuel generator 12 is purged outside the system by the air when the fuel cell system 150 starts-up. Thereby, the gases in the interiors of the anode 11a and the fuel generator 12 can be replaced by a specific gas, i.e., air, and therefore, the purge operation using the city gas can be thereafter carried out appropriately. In other words, gas atmosphere reset operation to replace the gas in the interiors of the anode 11a and the fuel generator 12 by the air is carried out.

While an air supply means including the air supply passage 31, the first air valve 32, the blower 33 and the air anti-backflow valve 34 is configured to supply the air to the portion of the material supply passage 14 located downstream of the pressure increasing device 23 and upstream of the position where the first bypass passage 18 branches from the material supply passage 14 in this embodiment, it may be supplied to a portion of the material supply passage 14 between the desulfurization device 22 and the pressure increasing device 23.

While the air is supplied in series to the fuel generator 12 and then to the fuel cell 11 as an example of a procedure for injecting the air, the air supply to the fuel generator 12 and the air supply to the fuel cell 11 can be carried out concurrently or independently by the opening and closing operation of the material bypass valve 20 and the opening and closing operation of the fuel gas switch valve 17.

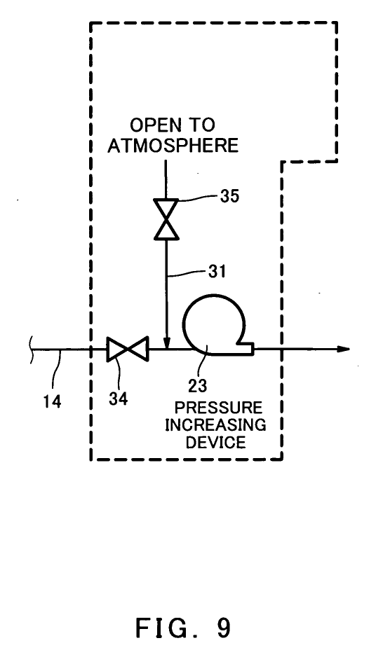

The components (air supply means and the pressure increasing device 23) defined by a broken line of FIG. 8 may be replaced by the pressure increasing device 23, the air anti-backflow valve 34 disposed at a position of the material supply passage 14 to be located upstream of the pressure increasing device 23, the air supply passage 31 disposed such that one end thereof opens to atmosphere and an opposite end thereof communicates with a portion of the material supply passage 14 between the pressure increasing device 23 and the air anti-backflow valve 34, and a second air valve 35 disposed at a position of the air supply passage 31, as shown in FIG. 9. Specifically, when the air is injected to the fuel generator 12, the controller 36 closes the air anti-backflow valve 34 and opens the second air valve 35. Under this condition, the controller 36 starts the operation of the pressure increasing device 23. Thereby, the pressure increasing device 23 serves as a blower configured to supply the air to the material supply passage 14, and the air suctioned from one end of the second air valve 35 can be guided to the portion of the material supply passage 14 (precisely, the portion of the material supply passage 14 between the pressure increasing device 23 and the air anti-backflow valve 34).

The fuel generator 12 is equipped with a shifter which contains a shift catalyst body containing at least one of platinum-group noble metals (platinum, ruthenium, rhodium, or palladium) and metal oxide, and a hydrogen supply device configured to supply hydrogen containing carbon monoxide and steam as secondary components to the shifter. This improves oxidization resistance of the shift catalyst body of the fuel generator 12. As a result, durability of the fuel cell system in the embodiment in which the air is injected to the fuel generator 12 can be improved.

Numerous modifications and alternative embodiments of the invention will be apparent to those skilled in the art in view of the foregoing description. Accordingly, the description is to be construed as illustrative only, and is provided for the purpose of teaching those killed in the art the best mode of carrying out the invention. The details of the structure and/or function may be varied substantially without departing from the spirit of the invention and all modifications which come within the scope of the appended claims are reserved.

### INDUSTRIAL APPLICABILITY

A fuel cell system of the present invention is capable of approximately purging an anode of a fuel cell using a feed gas when the fuel cell system starts-up, and therefore is useful as a fuel cell system for use at home or with automobile.

1. A fuel cell system comprising:
a fuel generator configured to generate a hydrogen-rich fuel gas by reforming a feed gas;
a material supply means configured to supply the feed gas to said fuel generator;
a fuel cell configured to generate electric power using the fuel gas supplied from said fuel generator and an oxidizing gas;
a bypass means configured to supply the feed gas to an anode of said fuel cell by bypassing said fuel generator;
a material supply switch means configured to switch a destination of the feed gas supplied from said material supply means between said fuel generator and said bypass means;
a material flow rate meter disposed at a position of a feed gas passage to be located between said material supply means and the anode and configured to measure a flow rate of the feed gas flowing through said bypass means; and
a controller,
wherein, at start-up of said fuel cell system, the feed gas is injected to the anode through said bypass means,
and said controller is configured to cause said material supply switch means to operate based on a value output from said material flow rate meter to stop supply of the feed gas to the anode, and to then start the supply of the feed gas to said fuel generator.

2. The fuel cell system according to claim 1, further comprising:
a desulfurization device provided in the feed gas passage and configured to remove a sulfur component from a city gas which is the feed gas.

3. The fuel cell system according to claim 1, further comprising:
a combustor configured to heat said fuel generator by combusting the feed gas supplied to the anode through said bypass means and exhausted from the anode, or the feed gas supplied from said material supply means.

4. The fuel cell system according to claim 1, further comprising:
a material flow rate adjusting means provided upstream of said material supply switch means and configured to adjust a flow rate of the feed gas supplied from said material supply means.

5. The fuel cell system according to claim 1, further comprising:
an air supply means configured to supply air to at least one of the anode and said fuel generator, wherein after said air supply means supplies the air to at least one of the anode and said fuel generator and stops the supply of the air, the feed gas is supplied to the anode through said bypass means.
